(19) United States
(12) Patent Application Publication
(10) Pub. No.: US 2008/0041175 A1
(43) Pub. Date: Feb. 21, 2008

(54) Screw Shaft having cushioning structure

(75) Inventors: Jui Long Hsu, Taichung (TW); Yueh Ling Chiu, Taichung (TW)

Correspondence Address: CHARLES E. BAXLEY, ESQ., 90 JOHN STREET, THIRD FLOOR, NEW YORK, NY, 10038, US

(73) Assignee: Hiwin Technologies Corp.

(21) Appl. No.: 11/494,012

(22) Filed: Jul. 27, 2006

(51) Int. Cl. F16H 25/20

(52) U.S. Cl. 74/89.36

(57) ABSTRACT

A screw shaft device includes a screw shaft having an outer helical groove and having an intermediate portion, the screw shaft includes a longitudinal bore, a ball nut is threaded with helical groove of the screw shaft, and a number of ball bearings or rolling members are disposed between the ball nut and the screw shaft for facilitating a movement of the ball nut relative to the screw shaft, an inserted member is disposed in the intermediate portion of the longitudinal bore of the screw shaft, and the other inserted members are disposed in the end portions of the screw shaft, and the inserted member are made of different materials.

### BACKGROUND OF THE INVENTION

1. Field of the Invention

The present invention relates to a screw shaft, and more particularly to a ball screw shaft device including an improved cushioning structure for suitably dissipating vibration and for increasing the allowable rotating velocity of the ball screw.

2. Description of the Prior Art

Various kinds of typical screw shaft devices have been developed and comprise a ball nut rotatably engaged onto a ball screw, and a number of rolling members, balls or ball bearings disposed or engaged between the ball nut and the ball screw for facilitating the rotational movement and the sliding movement of the ball nut relative to the ball screw.

For example, U.S. Pat. No. 5,809,829 to Seto et al. discloses one of the typical screw shaft devices for attaching to a plate work processing machine and also including a ball nut rotatably engaged onto a ball screw for forming or acting as a work feeding device. The ball screw includes a central portion provided or engaged in an outer portion and formed of a hard material for increasing the allowable rotating velocity of the ball screw and for moving and locating the plate work at a high speed.

The ball screw may have two ends supported by fixed bearing devices, and may have a middle or intermediate portion located distal to the fixed bearing devices, and all of the portions, including the two end portions and the middle or intermediate portion of the longitudinal cemented central portion are made of the same hard material. However, when the ball nut and the plate work are moved along the ball screw, the vibration amplitude in the middle or intermediate portion of the ball screw may still be too large.

U.S. Pat. No. 6,708,577 to Pizzoni et al. discloses another typical screw shaft device with increased vibration frequency and having improved vibration dissipation, and also including a ball nut rotatably engaged onto a ball screw for supporting and feeding work pieces, and the ball screw includes plugs or inserted terminals integrally inserted in end portions of the ball screw that is made of composite polymeric material, and includes a central cylindrical or longitudinal cavity formed therein for engaging or receiving granular material and for dissipating vibration.

However, the vibration amplitude in the middle or intermediate portion of the ball screw may be suitably decreased, particularly when the ball nut and the work pieces are moved in the middle or intermediate portion of the ball screw.

The present invention has arisen to mitigate and/or obviate the afore-described disadvantages of the conventional screw shaft devices.

### SUMMARY OF THE INVENTION

The primary objective of the present invention is to provide a screw shaft device including an improved cushioning structure for suitably dissipating vibration.

The other objective of the present invention is to provide a screw shaft device for increasing the allowable rotating velocity of the ball screw.

In accordance with one aspect of the invention, there is provided a screw shaft device comprising a screw shaft including a helical groove provided on an outer peripheral portion thereof, and including an intermediate portion and two end portions for being supported on supporting members, the screw shaft including a longitudinal bore formed through the intermediate portion and the two end portions of the screw shaft, a ball nut threaded and engaged with helical groove of the screw shaft for allowing the ball nut to be moved along the screw shaft, and a number of ball bearings or rolling members disposed and engaged between the ball nut and the screw shaft for facilitating a movement of the ball nut relative to the screw shaft, a first inserted member disposed in the intermediate portion of the longitudinal bore of the screw shaft, and at least one second inserted member disposed in the end portions of the screw shaft, and the first inserted member is made of a material different from the second inserted member.

The material for making the first inserted member includes an E/ρ value (E: Young's modulus or longitudinal elastic coefficient (kgf/cm²), and ρ:specific weight (kg/cm³)) greater than that of the second inserted member.

The first inserted member and the second inserted member are secured together with an adhesive material. The adhesive material is preferably a silicone material.

The longitudinal bore of the screw shaft includes an inner diameter “d”, and the screw shaft includes an outer diameter “D”, and d/D is ranged from 0.5 to 0.7. The screw shaft includes an outer peripheral shoulder formed in each of the end portions of the screw shaft for forming a diameter reduced end segment.

The screw shaft includes an inserted terminal disposed in each of the diameter reduced end segments of the screw shaft, for preventing the material for making the first inserted member from being disengaged from the longitudinal bore of the screw shaft.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a cross sectional view of a screw shaft device in accordance with the present invention;

FIG. 2 is a partial cross sectional view of the screw shaft device;

FIGS. 3, 4, 5 are cross sectional views of the screw shaft device, taken along lines 3-3, 4-4, and 5-5 of FIG. 2 respectively;

FIG. 6 is an enlarged partial cross sectional view of the screw shaft device; and

FIG. 7 is a partial cross sectional view similar to FIG. 2, illustrating the other arrangement of the screw shaft device.

### DETAILED DESCRIPTION OF THE PREFERRED EMBODIMENT

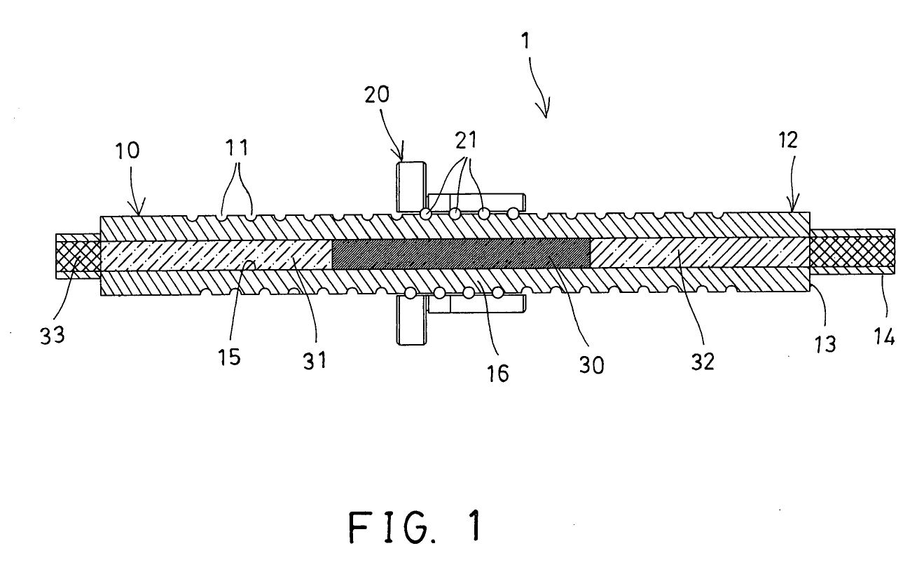

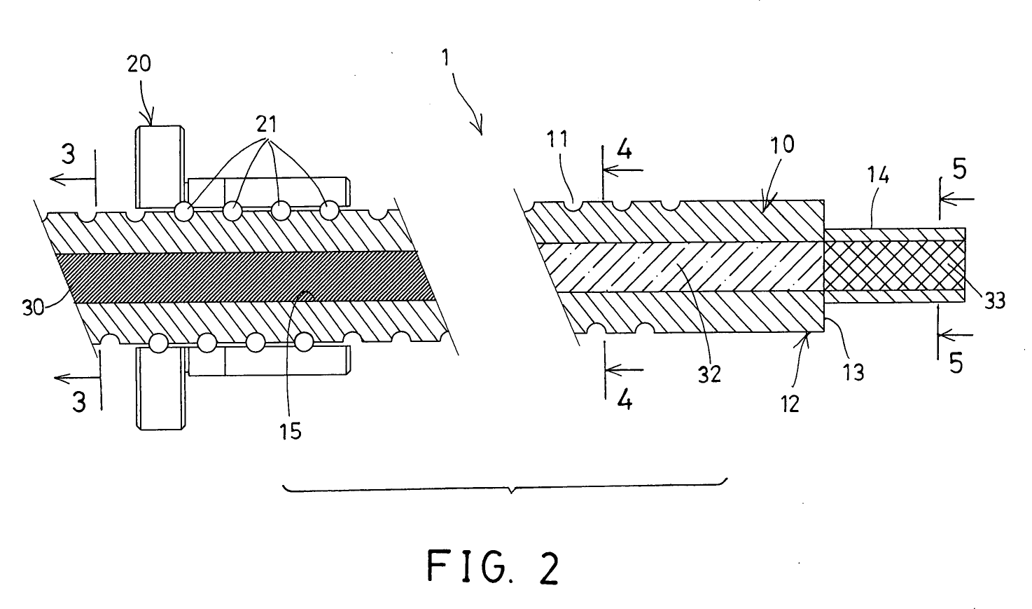

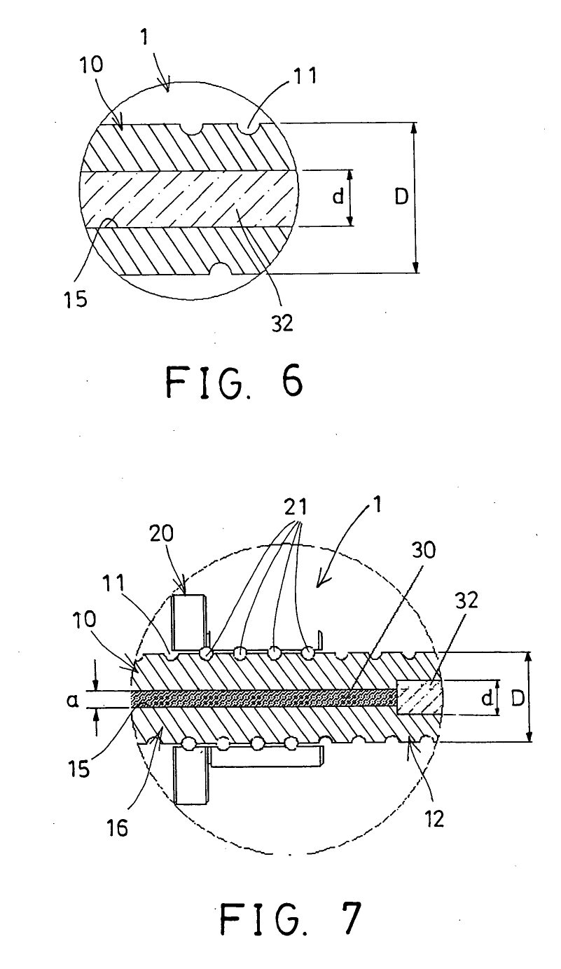

Referring to the drawings, and initially to FIGS. 1 and 2, a screw shaft device 1 in accordance with the present invention comprises a screw shaft 10 including a helical groove 11 formed or provided on the outer peripheral portion thereof, for threading or engaging with a ball nut 20 and for allowing the ball nut 20 to be moved or slid along the screw shaft 10, and a number of balls or ball elements or rolling members 21 disposed or engaged between the ball nut 20 and the screw shaft 10 for facilitating the rotational movement and/or the sliding movement of the ball nut 20 relative to the screw shaft 10, in which the screw shaft 10 includes an outer diameter “D” (FIG. 6).

The screw shaft 10 includes two end portions 12 for being supported on various supporting objects or members or machines (not shown) each having an outer peripheral shoulder 13 formed therein for forming or defining a diameter reduced end segments 14, and includes a cylindrical or longitudinal bore 15 provided therein and formed through the screw shaft 10 and the two end portions 12 or the diameter reduced end segments 14 of the screw shaft 10. It is preferable that the cylindrical or longitudinal bore 15 of the screw shaft 10 includes a uniform inner diameter “d” (FIG. 6) formed through out the length of the screw shaft 10, or formed through out the middle or intermediate portion 16 and the two end portions 12 and the diameter reduced end segments 14 of the screw shaft 10 (FIG. 1).

However, alternatively, as shown in FIG. 7, the inner diameter “a, d” of the cylindrical or longitudinal bore 15 of the screw shaft 10 may be changed or different in different portions of the screw shaft 10. For example, the inner diameter “a” of the cylindrical or longitudinal bore 15 of the screw shaft 10 may be smaller in the middle or intermediate portion 16 of the screw shaft 10, or the inner diameter “d” may be greater in the two end portions 12, depending on the requirements of the screw shaft 10, or depending on the materials to be engaged into the cylindrical or longitudinal bore 15 of the screw shaft 10, and it is preferable that (d/D)>(a/D).

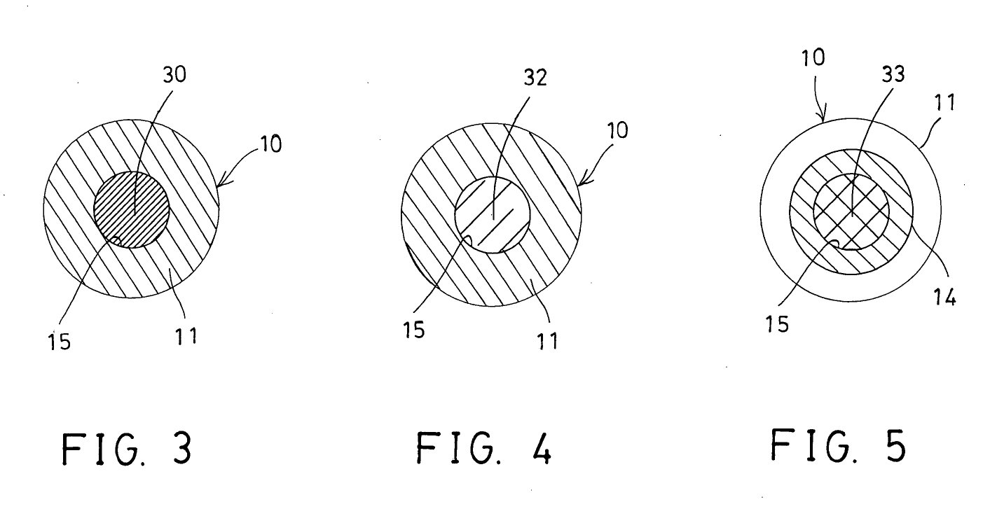

The screw shaft 10 further includes a first inserted material or member 30 (FIGS. 1-3) disposed or engaged in the middle or intermediate portion 16 of the cylindrical or longitudinal bore 15 of the screw shaft 10 where the amplitude of the vibration may be greater than the other portions, such as the two end portions 12 and/or the diameter reduced end segments 14 of the screw shaft 10, and one or more further or second inserted materials or members 31, 32 (FIGS. 1-2, 4, 6) disposed or engaged in the two end portions 12 of the screw shaft 10, and one or more plugs or inserted terminals 33 (FIGS. 1-2, 5) disposed or engaged in the diameter reduced end segments 14 of the screw shaft 10.

The first inserted member 30 includes an E/ρ value greater than the E/ρ value of the further inserted members 31, 32 which is preferably greater than the E/ρ value of the plugs or inserted terminals 33 that are disposed or engaged in the diameter reduced end segments 14 of the screw shaft 10, in which E: Young's modulus or longitudinal elastic coefficient (kgf/cm²), and ρ:specific weight (kg/cm³).

The maximum numbers Nc of revolutions of the screw shaft 10 may be obtained from the equation or formula:

Nc=60λ²/2πL²×{ExIxg/(ρ×A)}^{1/2},

in which λ: boundary parameter, I: inertia momentum, g: gravitational acceleration, and A: cross section of the screw shaft 10.

The maximum numbers Nc of revolutions of the screw shaft 10 is proportional to the value of {E/ρ}^{1/2}, and thus the maximum numbers Nc of revolutions of the screw shaft 10 may be suitably increased when the materials for making the screw shaft 10 include a greater {E/ρ}^{1/2} value, or when the screw shaft 10 and the materials or members 30-33 engaged into the screw shaft 10 include a greater {E/ρ}^{1/2} value, or when the materials or members 30-33 for engaging into the screw shaft 10 include a greater {E/ρ}^{1/2} value.

Accordingly, in the middle or intermediate portion 16 of the screw shaft 10, the amplitude of the vibration may be the greatest or may be greater than the other portions, such as the two end portions 12 and/or the diameter reduced end segments 14 of the screw shaft 10, and the provision and the engagement of the stronger first inserted material or member 30 (having greater {E/ρ}^{1/2} value) into the middle or intermediate portion 16 of the cylindrical or longitudinal bore 15 of the screw shaft 10 may suitably increase the maximum numbers Nc of revolutions of the screw shaft 10, and the further weaker inserted materials or members 31, 32 (having smaller {E/ρ}^{1/2} value) may be disposed or engaged in the two end portions 12 of the screw shaft 10 where the amplitude of the vibration may be relatively smaller.

As shown in FIG. 6, it is preferable that d/D=0.5˜0.7, and the inner diameter “d” of the cylindrical or longitudinal bore 15 of the screw shaft 10 or the outer diameter “d” of the materials or members 30-33 should be smaller than the outer diameter of the diameter reduced end segments 14 of the screw shaft 10. For example, when the inner diameter “d” of the cylindrical or longitudinal bore 15 of the screw shaft 10 is smaller than one half (½) of the outer diameter “D” of the screw shaft 10, the {E/ρ}^{1/2} value of the materials or members 30-32 may not be good enough to suitably increase the maximum numbers Nc of revolutions of the screw shaft 10. On the contrary, when the inner diameter “d” of the cylindrical or longitudinal bore 15 of the screw shaft 10 is greater, such as greater than seven tenth ( 7/10) of the outer diameter “D” of the screw shaft 10, the screw shaft 10 may be broken while machining the cylindrical or longitudinal bore 15 in the screw shaft 10.

The provision or the engagement of the plugs or inserted terminals 33 in the diameter reduced end segments 14 of the screw shaft 10 may position and retain the materials or members 30-32 in the cylindrical or longitudinal bore 15 of the screw shaft 10 and may prevent the materials or members 30-32 from being disengaged from the cylindrical or longitudinal bore 15 of the screw shaft 10. The materials or members 30-32 and the plugs or inserted terminals 33 are preferably solidly secured together with adhesive materials, such as silicone materials.

Accordingly, the screw shaft device in accordance with the present invention includes an improved cushioning structure for suitably dissipating vibration and for increasing the allowable rotating velocity of the ball screw.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A screw shaft device comprising:
a screw shaft including a helical groove provided on an outer peripheral portion thereof, and including an intermediate portion and two end portions for being supported on supporting members, said screw shaft including a longitudinal bore formed through said intermediate portion and said two end portions of said screw shaft,
a ball nut threaded and engaged with helical groove of said screw shaft for allowing said ball nut to be moved along said screw shaft, and
a plurality of rolling members disposed and engaged between said ball nut and said screw shaft for facilitating a movement of said ball nut relative to said screw shaft,
a first inserted member disposed in said intermediate portion of said longitudinal bore of said screw shaft, and
at least one second inserted member disposed in said end portions of said screw shaft, and
said first inserted member being made of a material different from said at least one second inserted member.

2. The screw shaft device as claimed in claim 1, wherein said material for making said first inserted member includes an E/ρ value greater than that of said at least one second inserted member.

3. The screw shaft device as claimed in claim 1, wherein said first inserted member and said at least one second inserted member are secured together with an adhesive material.

4. The screw shaft device as claimed in claim 3, wherein said adhesive material is a silicone material.

5. The screw shaft device as claimed in claim 1, wherein said longitudinal bore of said screw shaft includes an inner diameter “d”, and said screw shaft includes an outer diameter “D”, and d/D is ranged from 0.5 to 0.7.

6. The screw shaft device as claimed in claim 1, wherein said screw shaft includes an outer peripheral shoulder formed in each of said end portions of said screw shaft for forming a diameter reduced end segment.

7. The screw shaft device as claimed in claim 6, wherein said screw shaft includes an inserted terminal disposed in each of said diameter reduced end segments of said screw shaft, for preventing said material for making said first inserted member from being disengaged from said longitudinal bore of said screw shaft.
